(19) United States
(12) Patent Application Publication
(10) Pub. No.: US 2017/0169452 A1
(43) Pub. Date: Jun. 15, 2017

(54) RISK CALCULATION METHOD, COMPUTER-READABLE RECORDING MEDIUM, AND RISK CALCULATION APPARATUS

(71) Applicant: FUJITSU LIMITED, Kawasaki-shi (JP)

(72) Inventors: Takeaki Terada, Kawasaki (JP); Hiroshi Tsuda, Fujisawa (JP); Satoru Torii, Yokohama (JP); Yoshinori Katayama, Kawasaki (JP)

(73) Assignee: FUJITSU LIMITED, Kawasaki-shi (JP)

(21) Appl. No.: 15/364,700

(22) Filed: Nov. 30, 2016

(30) Foreign Application Priority Data
Dec. 11, 2015 (JP) 2015-242682

(51) Int. Cl. G06Q 30/02

(52) U.S. Cl. CPC G06Q 30/0204; G06Q 30/0203

(57) ABSTRACT

A risk calculation method includes: calculating a risk value based on psychological characteristic information indicating psychological characteristics unique to a user, and behavior characteristic information indicating behavior characteristics unique to the user in a predetermined time period obtained from a behavior history in the predetermined time period, among pieces of history information in which the behavior history of the user is recorded by a processor; and outputting alerts with respect to a user who has the calculated risk value exceeding a predetermined reference value by the processor.

### CROSS-REFERENCE TO RELATED APPLICATION

This application is based upon and claims the benefit of priority of the prior Japanese Patent Application No. 2015-242682, filed on Dec. 11, 2015, the entire contents of which are incorporated herein by reference.

### FIELD

The embodiment discussed herein is related to a risk calculation method, a computer-readable recording medium, and a risk calculation apparatus.

### BACKGROUND

Conventionally, in a business or commercial system for providing various services to a user, the security of the system is improved by outputting alerts to the user so that the user does not suffer from damage caused by cracking. As a technique of outputting alerts to a user, there has been known a technique that provides support information based on the user's confidence (self-assessment). As the damage caused by cracking, for example, there is a type of damage due to a targeted attack e-mail, and it is referred to as “IT attack” in the following descriptions.

However, in the conventional technique described above, because alerts are output based on static factors (elements) such as user's confidence (self-assessment) that does not change temporally, there is a problem such that the accuracy of alerts is low.

As a risk to the IT damage, for example, there are factors that dynamically change from hour to hour, such as an individual behavior being different according to a time period such as a time period after lunch where people feel sleepy, and business contents that change in the morning and in the afternoon. However, when alerts are output due to static factors that do not change temporally, the alerts may be output continuously irrespective of the time period, and thus it is difficult to handle a risk that dynamically changes from hour to hour.

### SUMMARY

According to an aspect of an embodiment, a risk calculation method includes: calculating a risk value based on psychological characteristic information indicating psychological characteristics unique to a user, and behavior characteristic information indicating behavior characteristics unique to the user in a predetermined time period obtained from a behavior history in the predetermined time period, among pieces of history information in which the behavior history of the user is recorded by a processor; and outputting alerts with respect to a user who has the calculated risk value exceeding a predetermined reference value by the processor.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a configuration example of a system according to an embodiment;

FIG. 2 is a flowchart illustrating an operation example of the system according to the embodiment;

FIG. 3 is an explanatory diagram for explaining temporal changes in a risk value;

FIG. 4 is an explanatory diagram for explaining temporal changes in a risk value;

FIG. 5 is an explanatory diagram for explaining a frequency distribution of a risk value;

FIG. 6 is an explanatory diagram illustrating an example of a data table of a risk value;

FIG. 7 is an explanatory diagram illustrating an example of a data table of a risk value;

FIG. 8 is an explanatory diagram illustrating an example of a data table of a risk value;

FIG. 9 is an explanatory diagram illustrating an example of a data table of a risk value;

FIG. 10 is a flowchart illustrating an operation example of a system according to a modification; and

FIG. 11 is a block diagram for exemplifying a hardware configuration of an information processor.

### DESCRIPTION OF EMBODIMENT

Preferred embodiments of the present invention will be explained with reference to accompanying drawings. In the embodiment, constituent elements having the same function are denoted by like reference characters and redundant explanations thereof will be omitted. The risk calculation method, the computer-readable recording medium, and the risk calculation apparatus described in the following embodiment are only examples, and the embodiment of the present invention is not limited thereto. In addition, the respective embodiments described below can be combined as appropriate within a range where these embodiments do not contradict to one another.

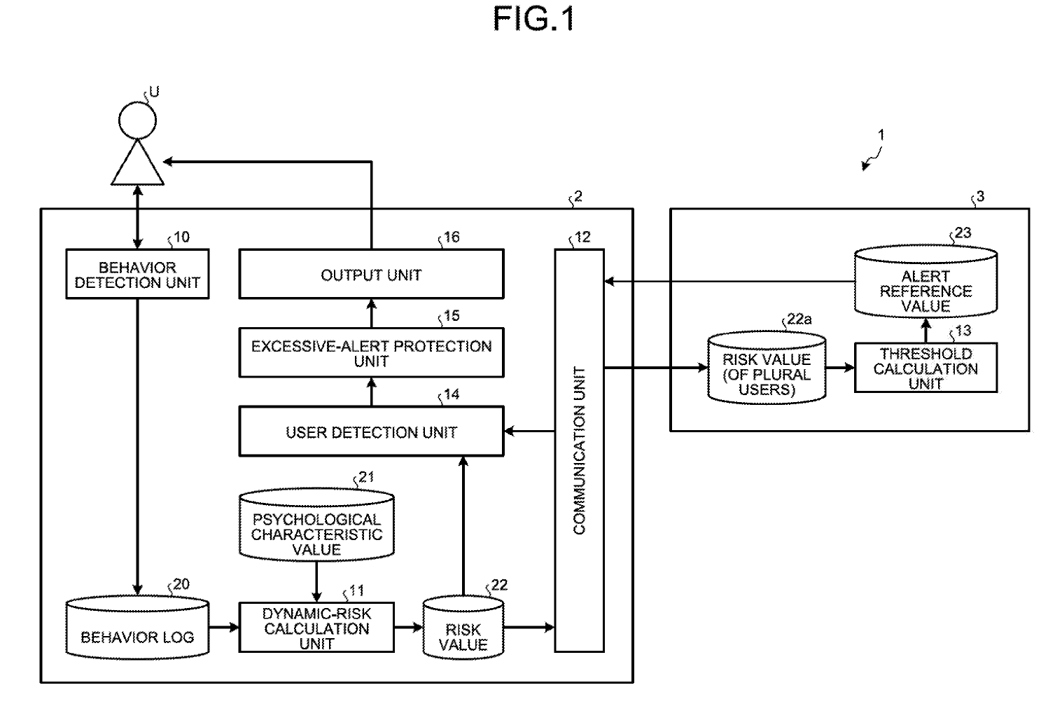

FIG. 1 is a block diagram illustrating a configuration example of a system 1 according to the present embodiment. As illustrated in FIG. 1, the system 1 includes a terminal device 2 and a server device 3 connected to the terminal device 2 via a communication network (not illustrated) such as a LAN (Local Area Network).

The terminal device 2 is an information processor (a computer) used by a user of, for example, a PC (personal computer) or a smartphone. The server device 3 is an information processor of the system 1 that accommodates the terminal device 2 as a client (C), and the server device 3 is a so-called “server (S)”. As an embodiment, a device such as a PC or a WS (workstation) can be adopted as the server device 3.

A program related to the client (C) or the server (S) is installed in each of the terminal device 2 and the server device 3. By operating the program on processors of the terminal device 2 and the server device 3, each of the terminal device 2 and the server device 3 can realize various functions of the client (C) or the server (S).

By operating a program on the processor, the terminal device 2 is provided with functions of a behavior detection unit 10, a dynamic-risk calculation unit 11, a communication unit 12, a user detection unit 14, an excessive-alert protection unit 15, and an output unit 16. Similarly, by operating a program on the processor, the server device 3 is provided with a function of a threshold calculation unit 13.

The behavior detection unit 10 detects the behavior of a user U via an input device such as a keyboard and a mouse. The behavior detection unit 10 records detected behavior contents in a behavior log 20 together with a detection time. Specifically, the behavior detection unit 10 records the detected behavior contents and the detection time in the behavior log 20, together with identification information (for example, a user ID) indicating the user U authenticated by a log-in authentication or the like. The behavior log 20 is data in which a behavior history of each user U, that is, behavior contents of the user U, is recorded in a chronological order.

The dynamic-risk calculation unit 11 extracts the behavior history of the user U in a predetermined time period from the behavior log 20 and obtains a behavior characteristic value indicating behavior characteristics unique to the user U in the time period from the extracted behavior history. The time period in which the dynamic-risk calculation unit 11 extracts the behavior history of the user U is a unit of time such as one hour or one day. For example, the dynamic-risk calculation unit 11 extracts the behavior history of the user U from the most recent time to one hour before or one day before from the behavior log 20. The dynamic-risk calculation unit 11 then calculates a risk value 22 indicating the risk of the user U to suffer from the IT damage, based on, for example, a psychological characteristic value 21 indicating psychological characteristics unique to the user U and the behavior characteristic value in the predetermined time period, which are obtained from a result of a survey with respect to users U.

For example, the dynamic-risk calculation unit 11 calculates the risk value 22 from a risk calculation formula of RS (risk value)=f(Ps)+g(B, T). In this risk calculation formula, Ps represents psychological characteristics, B represents behavior characteristics, and T represents a time period (a time). Further, f represents a function of Ps and g represents a function of B, T. The risk value (RS) calculated from the risk calculation formula is a value reflecting not only the static psychological characteristic value 21 having no temporal changes from the time when a survey is conducted, but also the behavior characteristic value of the user U that is different according to the time period such as a sleepy time period after lunch and business contents changing in the morning or in the afternoon. Accordingly, the risk value (RS) calculated by the dynamic-risk calculation unit 11 becomes a dynamic value that changes for each time period (T) in which the behavior characteristic value of the user U is obtained.

The dynamic-risk calculation unit 11 calculates the risk value 22 in each time period for each user U based on identification information (for example, a user ID) indicating the user U authenticated by a log-in authentication or the like. The risk value 22 of the user U calculated for each time period is stored in a data table or the like.

The communication unit 12 communicates with an external device (for example, the server device 3) via a communication network (not illustrated) such as a LAN (Local Area Network). Specifically, the communication unit 12 transmits the risk value 22 calculated by the dynamic-risk calculation unit 11 to the server device 3. Further, the communication unit 12 receives an alert reference value 23, which becomes a reference risk value (a threshold) for outputting alerts for the IT damage, from the server device 3. The communication unit 12 outputs the alert reference value 23 received from the server device 3 to the user detection unit 14.

The threshold calculation unit 13 calculates the alert reference value 23 by aggregating a plurality of risk values 22a of a plurality of users U received from one or a plurality of terminal devices 2. Specifically, the risk value 22 calculated for each user U is transmitted to the server device 3 via the communication unit 12, and accumulated in the risk values 22a. The threshold calculation unit 13 obtains statistical data such as a mean value and frequency distribution by aggregating the risk values 22a, thereby calculating the alert reference value 23 that becomes an indication for detecting a user U having a high risk of the IT damage. The threshold calculation unit 13 transmits the calculated alert reference value 23 to the terminal device 2 via the communication network.

For example, the threshold calculation unit 13 sets a mean value obtained by aggregating the risk values 22a as the alert reference value 23. In this case, a user U who has a higher risk of the IT damage than the average of a plurality of users U can be detected based on the calculated alert reference value 23. The threshold calculation unit 13 sets a boundary value of the risk value belonging to an upper predetermined range (for example, top several percent) as the alert reference value 23 based on the frequency distribution obtained by aggregating the risk values 22a. In this case, a user U having a risk value of IT damage belonging to the upper predetermined range can be detected based on the calculated alert reference value 23.

The user detection unit 14 compares the alert reference value 23 acquired from the server device 3 with the risk value 22 of each of the users U to detect a user U who has a risk value 22 exceeding the alert reference value 23. The user detection unit 14 outputs a detection result to the output unit 16 via the excessive-alert protection unit 15. The output unit 16 outputs alerts indicating that there is a risk of occurrence of the IT damage with regard to the user U, who has a risk value 22 exceeding the alert reference value 23, by displaying the alerts on a display, issuing a sound output, or the like.

The excessive-alert protection unit 15 prevents that alerts are continuously output in a short period of time and output of them becomes excessive, with regard to the user U who has a risk value 22 exceeding the alert reference value 23 detected by the user detection unit 14. Specifically, the excessive-alert protection unit 15 suppresses output of alerts when an elapsed time immediately after output of alerts is within a predetermined time, with regard to the user U having the same identification information such as a user ID.

The excessive-alert protection unit 15 obtains a frequency distribution of the risk value 22 over a plurality of time periods, for the user U having the same identification information such as a user ID. The excessive-alert protection unit 15 then causes the output unit 16 to output alerts without suppressing the output of alerts, if the current risk value 22 belongs to an upper predetermined range (for example, top several percent) in the obtained frequency distribution.

Accordingly, in a case where the current risk value 22 belongs to an upper predetermined range in the frequency distribution of the risk value 22 over a plurality of time periods, that is, in a case where the user U is susceptible to the IT damage, the excessive-alert protection unit 15 can output alerts to the user U. Further, when it is assumed that alerts are to be output when the risk value 22 belongs to the top 2% of the frequency distribution, the output of alerts can be suppressed to a frequency of about two times in a hundred hours, if the time period for obtaining the behavior characteristic value of the user U is in a unit of one hour, or to a frequency of about two days in a hundred days if the time period is in a unit of one day.

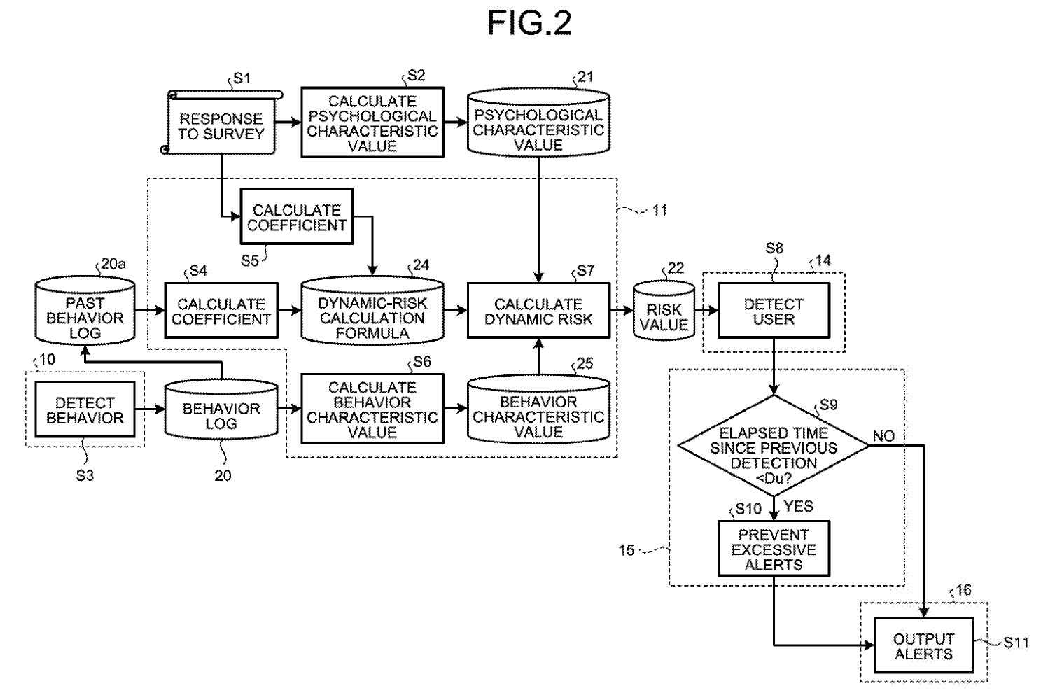

FIG. 2 is a flowchart illustrating an operation example of the system 1 according to the present embodiment. As illustrated in FIG. 2, the system 1 preliminarily conducts a survey with respect to users U for acquiring distinguishing psychological characteristics, thereby acquiring responses to the survey (S1). Subsequently, based on the acquired responses to the survey, the system 1 calculates and obtains a psychological characteristic value 21 indicating the psychological characteristics unique to the user U (S2). The psychological characteristic value 21 is updated every time the responses are acquired by the survey conducted at an interval, such as once in six months.

The survey conducted with respect to the users U includes question items related to a psychological state. Examples of the question items include an experience of opening a training e-mail regarding a targeted attack e-mail (an experience of executing a program), an experience of being infected with a virus, a question item for evaluating the degree of overconfidence, a question item for evaluating the degree of priority of short-term profits, and a question item asking the possibility of suffering from damage caused by cracking. Regarding the question items related to the psychological state such as the question item for evaluating the degree of overconfidence and the question item for evaluating the degree of priority of short-term profits, for example, the question items can include an item quantifying user's responses (evaluating user's responses by stage). Further, the survey can include not only the question item regarding the psychological state but also a question item for determining whether the user is a person whose awareness of the security issue is low, such as an experience of opening a training e-mail and an experience of being infected with a virus.

The psychological characteristic value 21 is obtained by quantifying psychological characteristics (Ps) such as overconfidence (Ps1), laziness (Ps2), priority of short-term profits (Ps3), and impatience (Ps4) based on responses to the question items.

The behavior detection unit 10 detects the behavior taken by the user U, and records the detected behavior contents together with the time in the behavior log 20 (S3). The behavior contents recorded in the behavior log 20 include, for example, a switching operation of screens, an e-mail transfer operation, and a display time of various screens (for example, a warning screen), in addition to the operations with a mouse and a keyboard.

The dynamic-risk calculation unit 11 performs coefficient calculation of a dynamic-risk calculation formula 24 in which a risk value (RS_u) of the user U is calculated by the sum or product of psychological characteristics (Ps_u) and behavior characteristics (B_u) of the user U.

In the dynamic-risk calculation formula 24, for example, the risk value of the user U (RS_u) is calculated according to the following expression (1). In the expression (1), α represents a coefficient of Ps_u, and β represents a coefficient of B_u.

RS_u=α*Ps_u+β*(B_u) (1)

When there are a plurality of psychological characteristics (Ps_u) and behavior characteristics (B_u) of the user U that are related to a risk, respective values of the user U can be expressed as Ps_{u, i} (i=1, 2, . . . , n), and B_{u, j} (j=1, 2, . . . , m), and the expression (1) can be expressed by the following expression (2).

RS_u=Σα_i*Ps_{u,i}+Σβ_j*B{u,j} (2)

In the expression (2), while the sum (Σ) is used, the product (Π) can be also used. α_i and β_j are coefficients in the respective characteristics (i, j). Further, the risk value of the user U (RS_u) at a certain time can be expressed by the following expression (3).

RS_{u,t}=Σα_i*Ps_{u,i,t}+Σβ_j*B{u,j,t} (3)

At S4 and S5, calculation of the coefficients (α_i, β_j) in the dynamic-risk calculation formula 24 is performed while designating a behavior log 20a in the past of about one month of the user U as a known value in the behavior characteristics (B), and a response to a survey at S1 as a known value in the psychological characteristics (Ps). The coefficient calculation is a known method disclosed in, for example, Japanese Laid-open Patent Publication No. 2015-176375, and is performed by using a conventional regression analysis method. Regarding the coefficients (α_i, β_j) in the dynamic-risk calculation formula 24, the coefficient obtained for each user U as described above can be used, or a coefficient value calculated in advance while designating a general user U as a model can be used.

The dynamic-risk calculation unit 11 calculates a behavior characteristic value 25 (B{u, j, T}) indicating behavior characteristics unique to the user U in a time period (T) (S6).

Specifically, a behavior characteristic value B{u, 1, T} indicating a time interval of key input, the number of click operations with a mouse within a certain time, and the number of operations with a delete key such as a backspace key is calculated, for example, based on the operation with the mouse and the keyboard. The behavior characteristic value B{u, 1, T} is a value such that, for example, the time interval becomes long and the number of operations increases as the attention of the user U decreases.

Furthermore, a behavior characteristic value B{u, 2, T} indicating the number of switching operations of active window screens as an operation object from a plurality of window screens is calculated based on the switching operation of the screens. The behavior characteristic value B{u, 2, T} is a value that increases when business is busy, for example.

A behavior characteristic value B{u, 3, T} indicating a display time of a reminder screen or the like is calculated based on the display time of the various screens. The behavior characteristic value B{u, 3, T} is a value that decreases when business is busy, for example. In this manner, the dynamic-risk calculation unit 11 calculates the behavior characteristic values 25 (B{u, 1, T}, B{u, 2, T}, . . . , B{u, j, T}) for each of the behavior characteristics of the user U in the time period (T).

The dynamic-risk calculation unit 11 then calculates the risk value 22 in the time period (T) of the user U by assigning the psychological characteristic value 21 of the user U and the behavior characteristic values 25 of the user U in the time period (T) to the dynamic-risk calculation formula 24.

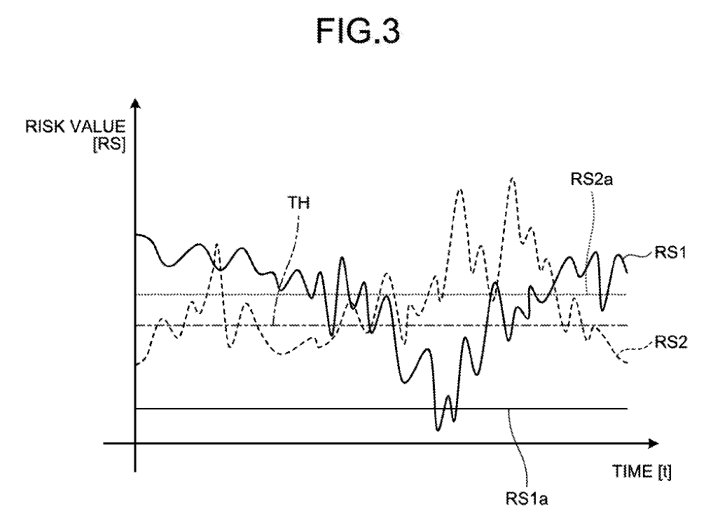

FIG. 3 is an explanatory diagram for explaining temporal changes in a risk value. In FIG. 3, TH represents the alert reference value 23 as a reference risk value (a threshold) for outputting alerts. RS1 represents a risk value obtained by assigning the psychological characteristic value 21 and the behavior characteristic values 25 for every time (t) to the dynamic-risk calculation formula 24 for a user A. Differently from RS1, RS1a represents a risk value obtained based on the psychological characteristic value 21 without using the psychological characteristic values 25 for every time (t). Similarly, RS2 represents a risk value obtained by assigning the psychological characteristic value 21 and the behavior characteristic values 25 for every time (t) to the dynamic-risk calculation formula 24 for a user B. RS2a is a risk value obtained based on the psychological characteristic value 21 without using the behavior characteristic values 25 for every time (t).

As illustrated in FIG. 3, the risk values (RS1a, RS2a), which are obtained based on the static psychological characteristic value 21 that does not have any temporal change since the time when a survey has been conducted without using the behavior characteristic values 25 for every time (t), do not change temporally. Therefore, for example, when the risk value exceeds the value TH (in the case of RS2a), alerts are continuously output irrespective of the time (t).

On the other hand, the risk value 22 (RS1 or RS2) calculated by the dynamic-risk calculation unit 11 is a temporally changing value that reflects not only the static psychological characteristic value 21 that does not have any temporal change since the time when the survey has been conducted but also the behavior characteristic values 25 of the user U different according to the time (t). Specifically, as illustrated in FIG. 3, the risk value RS1 of the user A or the risk value RS2 of the user B reflects the behavior characteristic values 25 changing hourly of the users A and B, and is a temporally changing value. The temporally changing behavior characteristic values 25 correctly reflect a sleepy time period after lunch and the business contents that change in the morning or in the afternoon. Accordingly, the dynamic-risk calculation unit 11 can obtain highly accurate risk values (RS1, RS2) corresponding to the risks of the user A and the user B that change dynamically.

The user detection unit 14 compares the alert reference value 23 acquired from the server device 3 with the risk value 22 of each user U, thereby detecting a user U who has a risk value 22 exceeding the alert reference value 23 (S8). The user detection unit 14 outputs a detection result to the output unit 16 via the excessive-alert protection unit 15. The output unit 16 outputs alerts indicating that there is a risk of occurrence of the IT damage for the user U who has a risk value 22 exceeding the alert reference value 23 based on the detection result from the user detection unit 14 (S11).

The excessive-alert protection unit 15 determines whether an elapsed time since the previous detection is less than a preset time (Du) with regard to the user U who has a risk value 22 exceeding the alert reference value 23 based on the detection result of the user detection unit 14 (S9). As the value of Du, for example, a value of about one day is appropriately set so as to leave a certain length of time spacing between outputs of alerts.

If the elapsed time since the previous detection is less than the preset time (Du) (S9: YES), the excessive-alert protection unit 15 suppresses the output of alerts from the output unit 16, thereby preventing excessive output of alerts (S10). If the elapsed time since the previous detection is not less than the preset time (Du) (S9: NO), the excessive-alert protection unit 15 does not suppress the output of alerts from the output unit 16 and causes the output unit 16 to directly output alerts with respect to the user U who has a risk value 22 exceeding the alert reference value 23.

The excessive-alert protection unit 15 can obtain the frequency distribution of the risk value 22 over a plurality of time periods for the user U having the same identification information such as a user ID, and compare the obtained frequency distribution with the current risk value 22, thereby suppressing alerts. For example, if the current risk value 22 does not belong to an upper predetermined range (for example, top several percent) in the obtained frequency distribution, it is not a remarkably risky state. Therefore, the excessive-alert protection unit 15 suppresses the output of alerts. If the current risk value 22 belongs to an upper predetermined range (for example, top several percent) in the obtained frequency distribution, the excessive-alert protection unit 15 causes the output unit 16 to output alerts without suppressing the output of alerts.

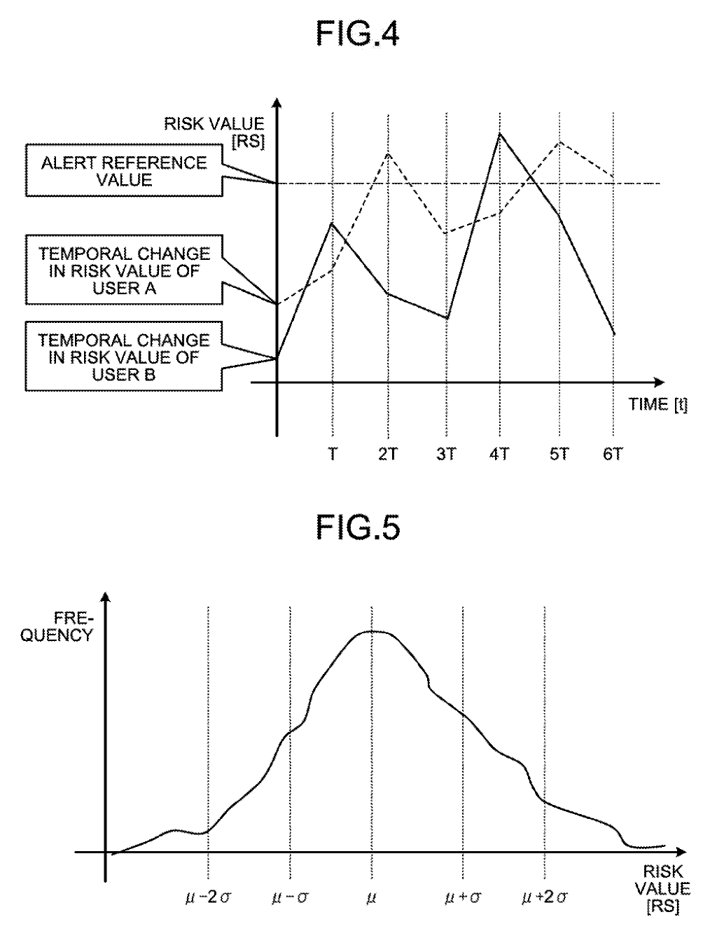

FIG. 4 is an explanatory diagram for explaining temporal changes in a risk value. As illustrated in FIG. 4, the risk values (RS) in the user A and the user B change according to the time period (T). The risk value of the user A has exceeded the alert reference value 23 at 2T and 5T. Therefore, for example, when 1T is in a unit of one hour, alerts are output every two hours, which means that alerts are frequently output. If alerts are frequently output, the user U may become too accustomed to the alerts and may not respond to the alerts quickly.

FIG. 5 is an explanatory diagram for explaining a frequency distribution of a risk value. As illustrated in FIG. 5, the excessive-alert protection unit 15 creates a frequency distribution of the individual risk value (RS) of the user U in a certain time period (for example, about 100T), and obtains an upper predetermined range that the user U hardly takes. For example, on an assumption that the frequency distribution follows a normal distribution, the excessive-alert protection unit 15 obtains a mean value (μ) and a standard deviation (σ), and obtains a risk value (=μ+2σ) that can be taken by the user U twice in 100 times (=2%).

As described above, the excessive-alert protection unit 15 obtains in advance a risk value that is in the upper predetermined range from the frequency distribution of the risk value (RS) for each user U, and determines whether the current risk value 22 belongs to the upper predetermined range. If the current risk value 22 does not belong to the upper predetermined range, it is not a remarkably risky state. Therefore, the excessive-alert protection unit 15 suppresses the output of alerts. If the current risk value 22 belongs to the upper predetermined range, the excessive-alert protection unit 15 causes the output unit 16 to output alerts. Due to this configuration, alerts can be output at a frequency not bothersome to the user U.

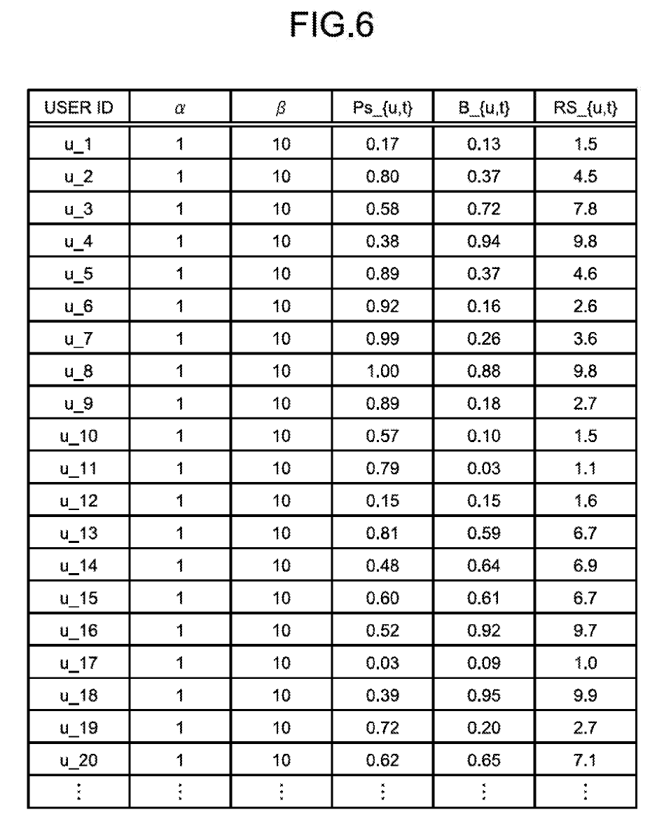

FIGS. 6 to 9 are explanatory diagrams illustrating examples of a data table of a risk value. As illustrated in FIG. 6, the risk value 22 calculated for each user U is managed in the table data provided for each user U (u_1, u_2, . . . ).

The risk value for each user U managed in the table data is transmitted to the server device 3 via the communication unit 12. The threshold calculation unit 13 of the server device 3 calculates the alert reference value 23 by aggregating the risk value of each user U and transmits the alert reference value 23 to the terminal device 2. It is assumed here that the value of the alert reference value 23 is calculated as 9.0.

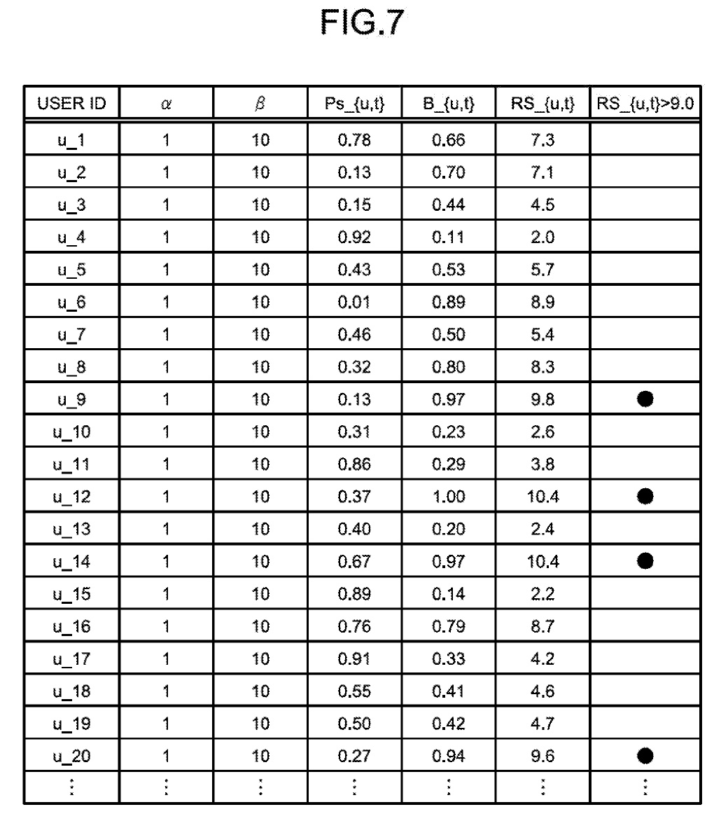

The user detection unit 14 refers to the table data provided for each user U (u_1, u_2, . . . ) and detects a user U who has a risk value exceeding the alert reference value 23 (9.0). Specifically, as illustrated in FIG. 7, users u_9, u_12, u_14, and u_20 (see the black dots) who have a risk value exceeding 9.0 are detected.

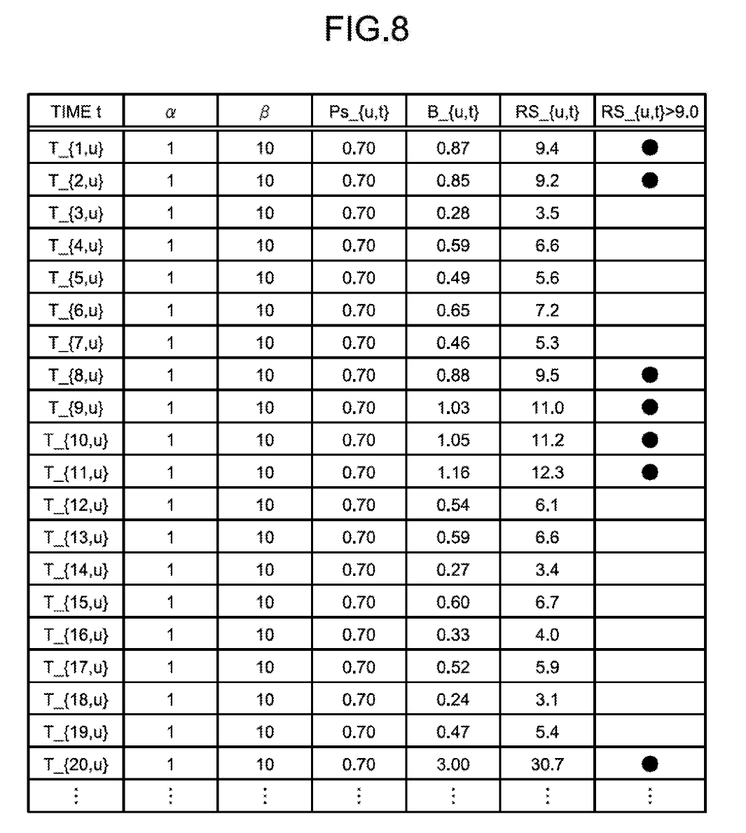

Next, as illustrated in FIG. 8, the excessive-alert protection unit 15 refers to the table data that stores therein hourly risk values (T_{1, u}, T_{2, u}, . . . ) of the user U, and, if an elapsed time immediately after output of the alert is within the predetermined time, suppresses the output of alerts.

For example, in the example illustrated in FIG. 8, when a unit of the time t is one hour, there are a plurality of times at which the risk value exceeds 9.0 (see the black dots) in 20 hours, and thus alerts are output frequently. Therefore, if the elapsed time immediately after output of the alert is within the predetermined time, by suppressing the output of the alert, it is prevented that the user U becomes too accustomed to the alerts.

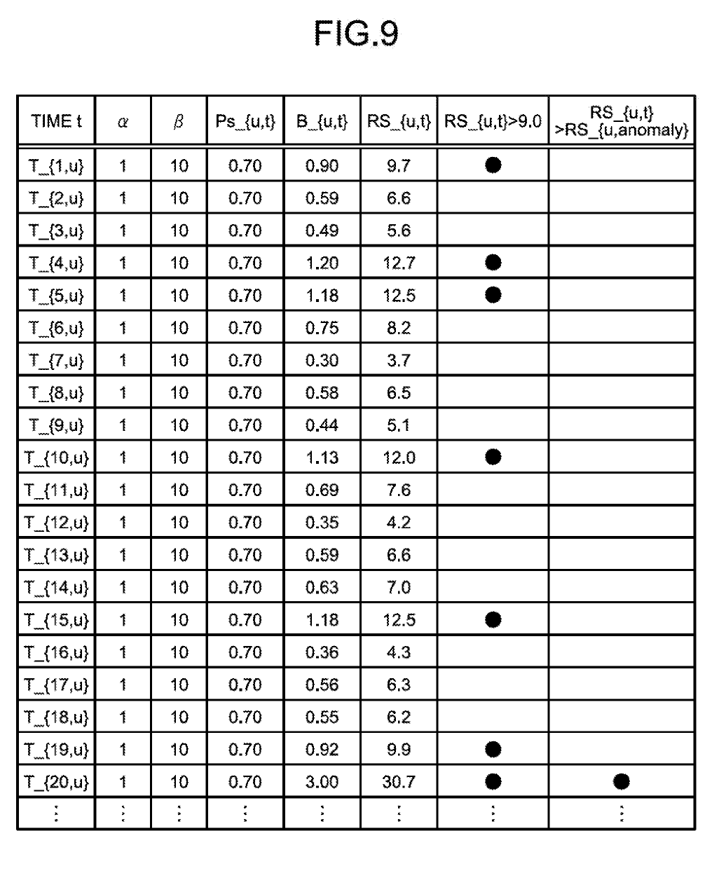

As illustrated in FIG. 9, the excessive-alert protection unit 15 refers to the table data storing therein the hourly risk values (T_{1, u}, T_{2, u}, . . . ) of the user U to obtain the frequency distribution of the risk value.

Specifically, the excessive-alert protection unit 15 obtains the mean value (μ) and the standard deviation (σ) in a predetermined time period (for example, (T {1, u} to T_{20, u}) by regarding the distribution of the risk value (RS_{u, t}) of the user U as a normal distribution. The excessive-alert protection unit 15 then obtains an upper risk value (RS_{u, anomaly}) that the user U hardly takes. For example, the excessive-alert protection unit 15 obtains a risk value (=μ+2σ) that can be taken by the user U with a probability of about 2%. If the current risk value 22 is a high risk value that can be taken by the user U with the probability of about 2%, the excessive-alert protection unit 15 causes the output unit 16 to output alerts.

In the example illustrated in FIG. 9, the risk value is one that can be taken with the probability of about 2% when the time is T_{20, u}, and thus alerts are output at this time.

Modification

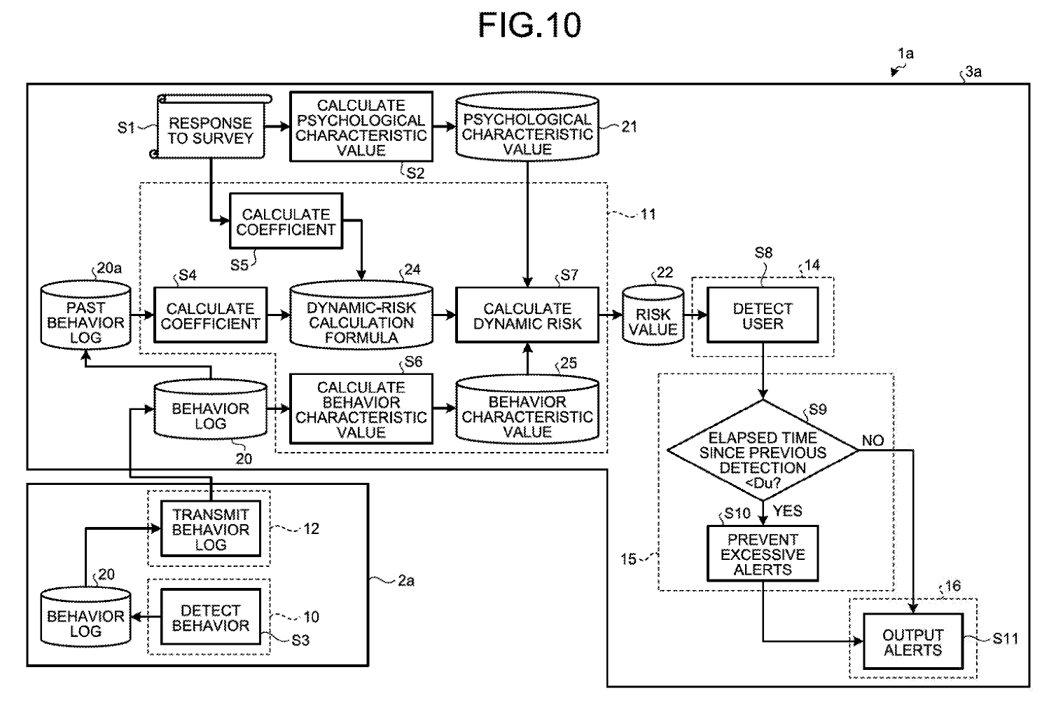

FIG. 10 is a flowchart illustrating an operation example of a system 1a according to a modification. As illustrated in FIG. 10, in the system 1a according to the modification, the behavior detection unit 10 of a terminal device 2a transmits the detected behavior log 20 to a server device 3a via the communication unit 12. The server device 3a performs calculation of the risk values 22 of the users U by the dynamic-risk calculation unit 11, detection of a user U by the user detection unit 14, prevention of excessive alerts by the excessive-alert protection unit 15, and output of alerts by the output unit 16. In this manner, it is possible to configure that the server device 3a collects the behavior log 20 from the terminal device 2a, and the processes of calculating the risk values 22 of the users U and outputting alerts on the side of the server device 3a are performed by the server device 3a.

As described above, in the system 1, based on the behavior log 20 in which the behavior history of the user U is stored, the dynamic-risk calculation unit 11 obtains the behavior characteristic value 25 indicating behavior characteristics unique to the user U in the predetermined time period (T) from a behavior history in the predetermined time period (T). Further, the dynamic-risk calculation unit 11 calculates the risk value 22 indicating a risk of the user U to suffer from the IT damage, based on the psychological characteristic value 21 indicating psychological characteristics unique to the user U and the behavior characteristic value unique to the user U in the predetermined time period (T). Further, in the system 1, the output unit 16 outputs alerts with respect to the user U who has the calculated risk value 22 exceeding the reference value. Therefore, the system 1 can handle a risk dynamically changing from hour to hour and can increase the accuracy of the alerts to be output based on the risk value.

Respective constituent elements of respective devices illustrated in the drawings do not necessarily need to be physically the same as illustrated. That is, specific modes of distribution and integration of the devices are not limited to those illustrated in the drawings, and a part of whole of these devices can be configured while they are functionally or physically distributed or integrated in an arbitrary unit, according to various loads and use statuses.

For example, in the present embodiment, the system 1 of a client/server (C/S) model including the terminal device 2 and the server device 3 has been exemplified. However, the device configuration can include only the terminal device 2 that realizes the threshold calculation unit 13 in the device itself. The server device 3 in the C/S model can use cloud computing.

In the present embodiment, the dynamic-risk calculation unit 11 obtains the risk value 22 for each user U. However, the risk value 22 obtained by the dynamic-risk calculation unit 11 is not limited to the risk value for each user U. For example, the dynamic-risk calculation unit 11 can aggregate risk values in a unit of group (for example, a department in a corporation) to which the user U belongs, to obtain the risk value 22 in the unit of group. When the risk value 22 in the unit of group is to be obtained, behavior characteristics different depending on the group, such as business contents, business hours, lunch time, and the presence of flexible business hours, can be reflected in the risk calculation (S7).

It is also possible to configure that an arbitrary part or all of various processing functions performed by the information processors of the terminal device 2 and the server device 3 are executed on a CPU (or a microcomputer such as an MPU or an MCU (Micro Controller Unit)). Further, needless to mention, an arbitrary part or all of the various processing functions can be executed in a program analyzed and executed by the CPU (or a microcomputer such as an MPU or an MCU) or on wired logic hardware.

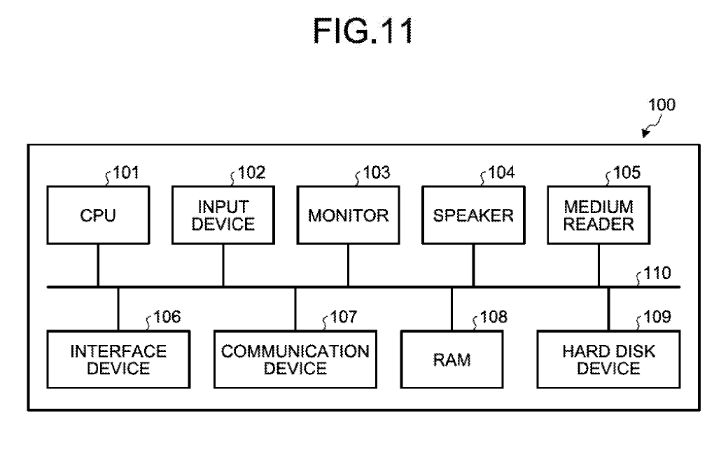

The various processes explained in the above embodiment can be realized by executing a program prepared in advance by a computer. Therefore, an example of a computer (hardware) that executes a program having the same functions as those of the present embodiment is described below. FIG. 11 is a block diagram for exemplifying a hardware configuration of an information processor 100.

As illustrated in FIG. 11, the information processor 100 includes a CPU 101 that performs various types of arithmetic processing, an input device 102 that receives data input, a monitor 103, and a speaker 104. The information processor 100 further includes a medium reader 105 that reads a program and the like from a recording medium, an interface device 106 for connection to various devices, and a communication device 107 for communication connection to an external device by a wired or wireless connection. The information processor 100 also includes a RAM 108 for temporarily storing various pieces of information and a hard disk device 109. Various units (101 to 109) in the information processor 100 are connected to a bus 110.

A program having identical functions to those of the respective processing units of the behavior detection unit 10, the dynamic-risk calculation unit 11, the communication unit 12, the threshold calculation unit 13, the user detection unit 14, the excessive-alert protection unit 15, and the output unit 16 are stored in the hard disk device 109. Various pieces of data for realizing the program is also stored in the hard disk device 109. The input device 102 receives an input of operation information, for example, from an operator of the information processor 100. The monitor 103 displays various screens operated, for example, by the operator. The interface device 106 is connected with, for example, a printer or the like. The communication device 107 is connected to a communication network such as a LAN (Local Area Network) to exchange various pieces of information with an external device via the communication network.

The CPU 101 reads the respective programs stored in the hard disk device 109 and executes the respective programs by developing the programs in the RAM 108, thereby performing various processes. These programs can cause the information processor 100 to function as the behavior detection unit 10, the dynamic-risk calculation unit 11, the communication unit 12, the threshold calculation unit 13, the user detection unit 14, the excessive-alert protection unit 15, and the output unit 16.

The programs described above do not always need be stored in the hard disk device 109. For example, the information processor 100 can read a program stored in a recording medium that can be read by the information processor 100 and execute the program. The recording medium that can be read by the information processor 100 is, for example, a portable recording medium such as a CD-ROM, a DVD disk, or a USB (Universal Serial Bus) memory, a semiconductor memory such as a flash memory, or a hard disk drive. Further, it is also possible to configure that the program is stored in devices being connected to a public line, the Internet, a LAN (Local Area Network), or the like, and the information processor 100 can read the program from these devices and execute the program.

According to an embodiment of the present invention, the accuracy of alerts can be improved.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A risk calculation method comprising:
calculating a risk value based on psychological characteristic information indicating psychological characteristics unique to a user, and behavior characteristic information indicating behavior characteristics unique to the user in a predetermined time period obtained from a behavior history in the predetermined time period, among pieces of history information in which the behavior history of the user is recorded by a processor; and
outputting alerts with respect to a user who has the calculated risk value exceeding a predetermined reference value by the processor.

2. The risk calculation method according to claim 1, wherein when an elapsed time immediately after output of an alert is within a predetermined time, the outputting alerts suppresses output of alerts with respect to a user who has the calculated risk value exceeding a predetermined reference value.

3. The risk calculation method according to claim 1, wherein the outputting alerts outputs the alerts when the calculated risk value belongs to an upper predetermined range in a frequency distribution of the risk value of the user calculated for a plurality of time periods.

4. The risk calculation method according to claim 1, further comprising:
calculating the reference value based on an aggregation result of risk values calculated for each of a plurality of users, and
the outputting alerts outputs alerts with respect to a user who has the calculated risk value exceeding the calculated reference value.

5. The risk calculation method according to claim 1, wherein the calculating obtains the behavior characteristic information based on at least one value of an input interval of the user included in the behavior history, number of operations with a delete key, and number of switching operations of a window screen as an operation object.

6. A non-transitory computer-readable recording medium having stored therein a program that causes a computer to execute a process including:
calculating a risk value based on psychological characteristic information indicating psychological characteristics unique to a user, and behavior characteristic information indicating behavior characteristics unique to the user in a predetermined time period obtained from a behavior history in the predetermined time period, among pieces of history information in which the behavior history of the user is recorded; and
outputting alerts with respect to a user who has the calculated risk value exceeding a predetermined reference value.

7. The non-transitory computer-readable recording medium according to claim 6, wherein when an elapsed time immediately after output of an alert is within a predetermined time, the outputting alerts suppresses output of alerts with respect to a user who has the calculated risk value exceeding a predetermined reference value.

8. The non-transitory computer-readable recording medium according to claim 6, wherein the outputting alerts outputs the alerts when the calculated risk value belongs to an upper predetermined range in a frequency distribution of the risk value of the user calculated for a plurality of time periods.

9. The non-transitory computer-readable recording medium according to claim 6, wherein the process further including:
calculating the reference value based on an aggregation result of risk values calculated for each of a plurality of users, and
the outputting alerts outputs alerts with respect to a user who has the calculated risk value exceeding the calculated reference value.

10. The non-transitory computer-readable recording medium according to claim 6, wherein the calculating obtains the behavior characteristic information based on at least one value of an input interval of the user included in the behavior history, number of operations with a delete key, and number of switching operations of a window screen as an operation object.

11. A risk calculation apparatus comprising a processor that executes a process comprising:
calculating a risk value based on psychological characteristic information indicating psychological characteristics unique to a user, and behavior characteristic information indicating behavior characteristics unique to the user in a predetermined time period obtained from a behavior history in the predetermined time period, among pieces of history information in which the behavior history of the user is recorded; and
outputting alerts with respect to a user who has the calculated risk value exceeding a predetermined reference value.

12. The risk calculation apparatus according to claim 11, wherein when an elapsed time immediately after output of an alert is within a predetermined time, the outputting alerts suppresses output of alerts with respect to a user who has the calculated risk value exceeding a predetermined reference value.

13. The risk calculation apparatus according to claim 11, wherein the outputting alerts outputs the alerts when the calculated risk value belongs to an upper predetermined range in a frequency distribution of the risk value of the user calculated for a plurality of time periods.

14. The risk calculation apparatus according to claim 11, wherein the process further comprising:
calculating the reference value based on an aggregation result of risk values calculated for each of a plurality of users, and
the outputting alerts outputs alerts with respect to a user who has the calculated risk value exceeding the calculated reference value.

15. The risk calculation apparatus according to claim 11, wherein the calculating obtains the behavior characteristic information based on at least one value of an input interval of the user included in the behavior history, number of operations with a delete key, and number of switching operations of a window screen as an operation object.
